(19) United States
(12) Patent Application Publication
(10) Pub. No.: US 2017/0138587 A1
(43) Pub. Date: May 18, 2017

(54) MULTI-FUNCTIONAL FLASHLIGHT

(71) Applicant: NINGBO TIANLI LANTERN DECORATIONS CO., LTD., Yuyao City (CN)

(72) Inventor: Jiming Lu, Yuyao City (CN)

(73) Assignee: NINGBO TIANLI LANTERN DECORATIONS CO., LTD.

(21) Appl. No.: 15/216,284

(22) Filed: Jul. 21, 2016

(30) Foreign Application Priority Data
Nov. 16, 2015 (CN) 201520910336.1

(51) Int. Cl. F21V 33/00; F21V 23/00; A62B 3/00; F21L 4/00; F21V 31/00; F21V 15/04; F21V 23/04; F21V 17/12

(52) U.S. Cl. CPC F21V 33/0084; F21V 23/04; F21V 23/003; F21V 17/12; F21L 4/005; F21V 31/005; F21V 15/04; A62B 3/005; F21Y 2115/10

(57) ABSTRACT

A multifunctional flashlight includes a housing having a head, a hollow tube, a rear cover, a headlamp, two groups of LED, a switch, a control circuit board and a holding frame; wherein, the two groups of LED, the headlamp, the control circuit board and the switch are connected to form a lighting circuit; the switch is a multi-stage switch enabling the two groups of LED and the headlamp to be switched between a lighting mode and a flicking mode; an emergency hammer attached to the head; a seatbelt cutter attached to the head, opposing the emergency hammer. The flashlight is highly practical; it increases the functions of a flashlight by integrating an emergency hammer for breaking the glass, a seatbelt cutter, a flashlight, a working lamp for repairing outdoor and a safety warning lamp together.

### RELATE APPLICATIONS

This application claims benefit to Chinese Patent Application 201520910336.1, filed on Nov. 16, 2015, the specification of which is incorporated herein by this reference.

### FIELD OF THE INVENTION

The present invention relates to a flashlight and in particular to a multifunctional flashlight.

### DESCRIPTION OF THE PRIOR ART

Various lighting fixtures rise in response to the needs of lighting in people's daily life and work, among of which flashlights are very popular since they are convenient to carry and flexible to use. At present, LED light sources have been applied to flashlights due to their low power consumption, high light emitting efficiency, low heat generation and the like. Most of the flashlights often have only one lighting mode and are thus limited in function.

A Chinese Patent CN203231091U (Patent No.: CN201320114494.7), with a title “MULTIFUNCTIONAL FLASHLIGHT FOR VEHICLES”, disclosed a multifunctional flashlight. This multifunctional flashlight for vehicles includes an emergency flashlight housing, an emergency flasher housing, a handle, an emergency hammer, a seatbelt cutter, a flashlight switch, a flasher switch, a super white LED lamp, a super magnet, characterized in that the super white LED lamp is arranged on a top end of the flashlight housing, and the flashlight housing is connected to the emergency flasher housing in which a super red LED lamp is provided; the handle is connected to a lower end of the emergency flasher housing; batteries are provided in an inner cavity of the handle; both the flashlight switch and the flasher switch are arranged in the middle of the handle; the super magnet is arranged at a rear end of the handle; the emergency hammer is located on one side of the rear end of the handle while the seatbelt cutter is located on the other side of the handle; and a blade is provided inside the seatbelt cutter. Such a flashlight is multifunctional in lighting, rescuing, cutting off the seatbelt, and serving as an emergency hammer for escaping from the interior of the vehicle. However, in terms of lighting, such a flashlight is not enough for lighting since it has only one bulb if the vehicle is to be repaired at night. It cannot be used as a working lamp. Additionally, since the emergency hammer and the seatbelt cutter are both arranged at the rear end of the handle of the flashlight, it is incontinent to grip the handle when the emergency hammer and the seatbelt cutter are to be used, and furthermore, the flashlight cannot play the lighting role very well if the emergency hammer and the seatbelt cutter are to be used at night. Hence, this structure is not so reasonable and is to be further improved.

### SUMMARY OF THE INVENTION

A technical problem to be solved by the present invention is to provide, in view of the prior art, a multifunctional flashlight with reasonable structure and safe and convenient operation.

To solve the technical problem, the multifunctional flashlight comprises a housing having a head, a hollow tube, and a rear cover, the hollow tube having an upper portion and a lower portion; a headlamp disposed inside the head; two groups of LED, a switch, a control circuit board and a holding frame respectively disposed inside the hollow tube; an emergency hammer attached to the head; and a seatbelt cutter attached to the head, opposing the emergency hammer; wherein, the holding frame is disposed inside the upper portion of the hollow tube and close to the head; two groups of LEDs are distributed along the lengthways of the hollow tube, one group of LEDs on a left side and other group of LEDs on a right side of the holding frame; the switch is disposed on a front side of the holding frame; the two groups of LED, the headlamp, the control circuit board and the switch are connected to form a lighting circuit; the switch is a multi-stage switch enabling the two groups of LED and the headlamp to be switched between a lighting mode and a flicking mode.

Preferably, the hollow tube further comprises an inner tube and an outer tube, the outer tube having an upper portion and a lower portion; the inner tube is transparent, and has a through hole for the switch to pass through; the outer tube has a button corresponding to the switch, and the outer tube has a plurality of holes distributed on the outer tube corresponding to the two groups of LED to make the two groups of LED exposed outside.

Preferably, the outer tube is made of elastic TPR soft rubber material and wrapped around the inner tube; the outer tube has a plurality of annular ribs arranged at intervals in the upper portion of the outer tube, and two up and down adjacent holes separated by one annular rib.

Preferably, the head is made of aluminum material and shaped in sleeve, the head is attached on a top of the hollow tube by screws; a supporting frame having an upper portion and a lower portion, for the headlamp to disposed on, is provided inside the head; the upper portion of the supporting frame is attached to the head, the lower portion of the supporting frame is attached to the hollow tube, the lower portion of the supporting frame is resisted against the top of the holding frame.

As a further improvement, a lens coaxial with the headlamp is disposed on a top of the head.

As a further improvement, the head has a connecting threaded hole transversely disposed at one side of the head; the emergency hammer has a cone-tip shape head, and the emergency hammer has a rear with a threaded connecting post for threading into the connecting threaded hole, the emergency hammer has a guard, disposed at middle of the emergency hammer, for protecting the emergency hammer.

Preferably, the seatbelt cutter includes a blade rest and a blade disposed on the blade rest; and the head has a mount for receiving the blade rest.

Preferably, a battery rack is disposed inside the hollow tube; the holding frame has a plurality of protrusions at the bottom of the holding frame and inserted into the battery rack; and a spring disposed between the battery rack and the holding frame.

Preferably, the rear cover is coupled to a bottom of the inner tube, and a rear box is provided inside the rear cover and pressing against the battery rack.

Compared with the prior art, in the present invention, the two groups of LED on the two sides of the hollow tube greatly improves the lighting range and effect, so that this flashlight can serve as both a warning lamp and a working lamp;

since the headlamp and the working lamp can have the function of lighting or flicking, a warning effect is additionally provided; due to the arrangement of the emergency hammer and the seatbelt cutter on the two sides of the head, it is convenient for gripping and also for lighting when in use since they are in the same direction as the head;

the head is firm and increased in weight since it is made of Aluminum material, so that the emergency hammer provides a greater inertia moment when breaking the glass;

the outer tube has excellent waterproof performance and sealing performance and also has shock absorption and crash proof performance since it is made of elastic TPR soft rubber material;

the multifunctional flashlight of the present invention has reasonable structure and safe and convenient operation, and greatly increases the functions of a flashlight by integrating an emergency hammer for breaking the glass, a seatbelt cutter, a flashlight, a working lamp for repairing outdoor and a safety warning lamp together. Hence, the multifunctional flashlight of the present invention is highly practical.

### BRIEF DESCRIPTION OF THE DRAWINGS

FIG. 1 is a perspective view of a multifunctional flashlight according a first embodiment of the present invention.

FIG. 2 is a longitudinal sectional view of the multifunctional flashlight according the first embodiment of the present invention.

FIG. 3 is an exploded view of the multifunctional flashlight according the first embodiment of the present invention.

FIG. 4 is a perspective view of a multifunctional flashlight according a second embodiment of the present invention.

FIG. 5 is a longitudinal sectional view of the multifunctional flashlight according the second embodiment of the present invention.

### DETAILED DESCRIPTION OF THE PREFERRED EMBODIMENT

To enable a further understanding of the present invention content of the invention herein, refer to the detailed description of the invention and the accompanying drawings below:

### Embodiment 1

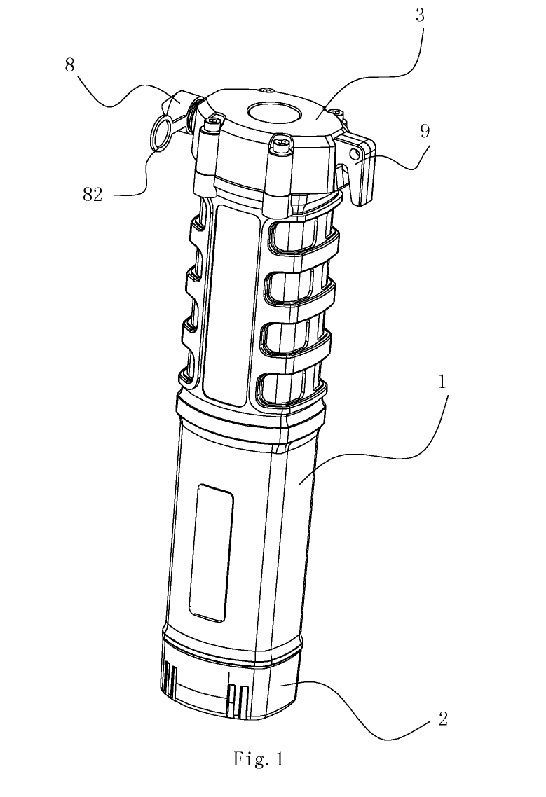

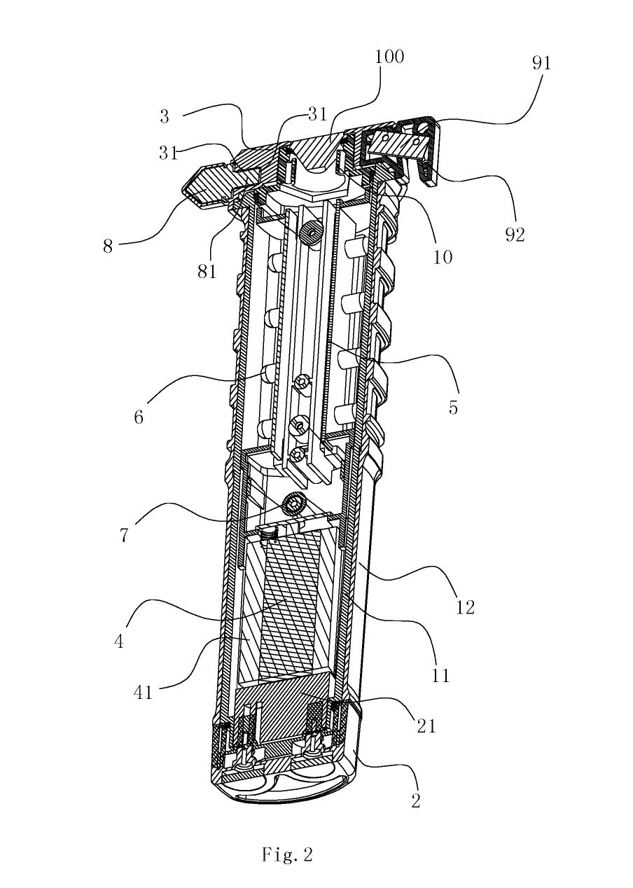

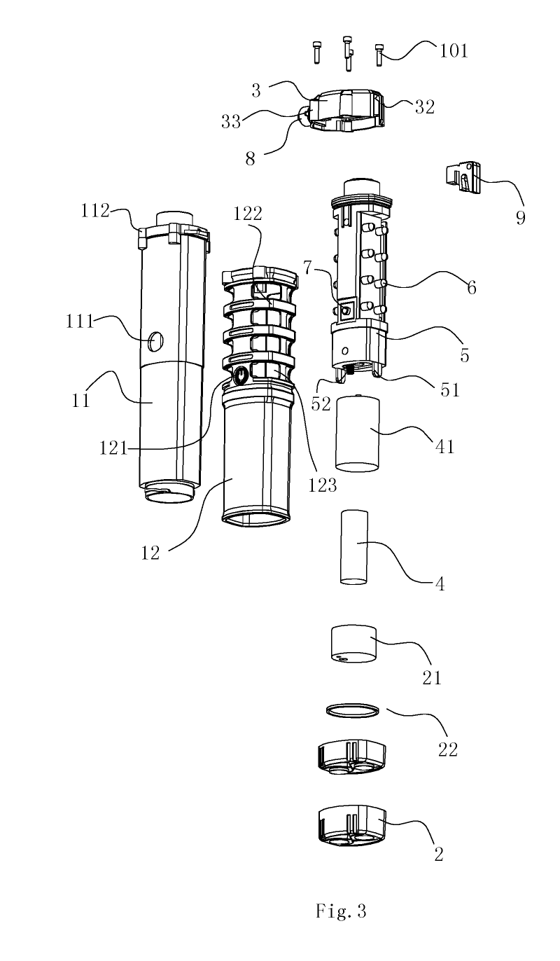

FIG. 1-FIG. 3 show a first embodiment of the multifunctional flashlight. The multifunctional flashlight comprises a housing having a head 3, a hollow tube 1, and a rear cover 2, the hollow tube 1 having an upper portion and a lower portion; a headlamp disposed inside the head 3; a plurality of batteries 4 disposed inside the lower portion of the hollow tube 1; two groups of LED 6, a switch 7, a control circuit board and a holding frame 5 respectively disposed inside the hollow tube 1; an emergency hammer 8 attached to the head 3; and a seatbelt cutter 9 attached to the head 3, opposing the emergency hammer; wherein, the holding frame 5 is disposed inside the upper portion of the hollow tube 1 and close to the head 3; two groups of LEDs 6 are distributed along the lengthways of the hollow tube 1, one group of LEDs on a left side and other group of LEDs on a right side of the holding frame 5; the switch 7 is disposed on a front side of the holding frame 5; the batteries 4 are arranged in the lower part of the hollow tube 1; the two groups of LED 6, the headlamp, the batteries, the control circuit board and the switch 7 are connected to form a lighting circuit; the switch 7 is a multi-stage switch, when the switch 7 is pressed down, the two groups of LED and the headlamp can be switched between a lighting mode and a flicking mode; the hollow tube 1 further comprises an inner tube 11 and an outer tube 12, the outer tube having an upper portion and a lower portion; the inner tube 11 is transparent so that light from the two groups of LED can be transmitted conveniently, and has a through hole 111 for the switch 7 to pass through; the outer tube 12 is made of elastic TPR soft rubber material so that it has excellent waterproof performance and sealing performance, and is wrapped around the inner tube 11; the outer tube 12 has a button 121 arranged at the middle of the front side corresponding to the switch 7; the outer tube 12 has a plurality of annular ribs 122 arranged at intervals in the upper portion of the outer tube 12, and the ribs 122 can have shock absorption and crash proof performance; the outer tube 12 has a plurality of holes 123 distributed on the outer tube 12 corresponding to the two groups of LED 6 to make the two groups of LED 6 exposed outside; the head 3 is attached on a top of the hollow tube 1 in an folded manner, and four connecting posts 33 having connecting holes are provided on the periphery of the head 3; four columns 112 having internally threaded holes are correspondingly provided on the periphery of the upper end of the inner tube 1, and the head 3 is connected to the inner tube 11 in a folded manner by four screws 101; the head 3 is shaped in sleeve; a supporting frame 10 having an upper portion and a lower portion, for the headlamp to disposed on, is provided inside the head 3; the upper portion of the supporting frame 10 is attached to the head 3, the lower portion of the supporting frame 10 is attached to the hollow tube 1, the lower portion of the supporting frame 10 is resisted against the top of the holding frame 5; a lens 100 coaxial with the headlamp is disposed on a top of the head 3, so that light from the headlamp is emergent in the axial direction, leading to circular and uniform spots; an emergency hammer 8 attached to the head 3; and a seatbelt cutter 9 attached to the head 3, opposing the emergency hammer; the head 3 is made of aluminum material, so that the emergency hammer 8 provides a greater inertia moment when breaking the glass; the head 3 has a connecting threaded hole 31 transversely disposed at one side of the head 3; the emergency hammer 8 has a cone-tip shape head, and the emergency hammer 8 has a rear with a threaded connecting post for threading into the connecting threaded hole 31; the emergency hammer 8 has a guard 82, disposed at middle of the emergency hammer, for protecting the emergency hammer 8; the seatbelt cutter 9 includes a blade rest 92 and a blade 91 disposed on the blade rest 92; and the head 3 has a mount for receiving the blade rest 92; the batteries 4 is disposed inside a battery rack 41 and located below the holding frame 5; the holding frame 5 has a plurality of protrusions 51 at the bottom of the holding frame 5 and inserted into the battery rack 41; and a spring 52 disposed between the battery rack 41 and the holding frame 5; the rear cover 2 is coupled to a bottom of the inner tube 11, and a rear box 21 is provided inside the rear cover 2 and pressing against the battery rack 41.

When in use, the switchover between the flashlight mode, the working lamp mode and the warning lamp mode is achieved by pressing down the buttons, so that the flashlight of the embodiment can serve as a flashlight, a working lamp and a warning lamp, and also as an emergency hammer for escaping from the interior of the vehicle. Furthermore, in the case in which the seatbelt cannot be released when in accidents, the seatbelt can be cut off by the seatbelt cutter.

### Embodiment 2

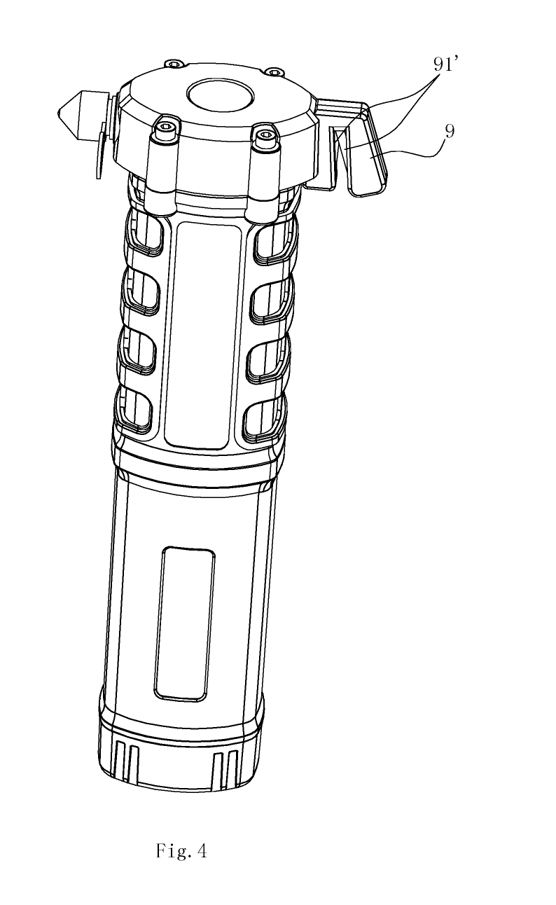

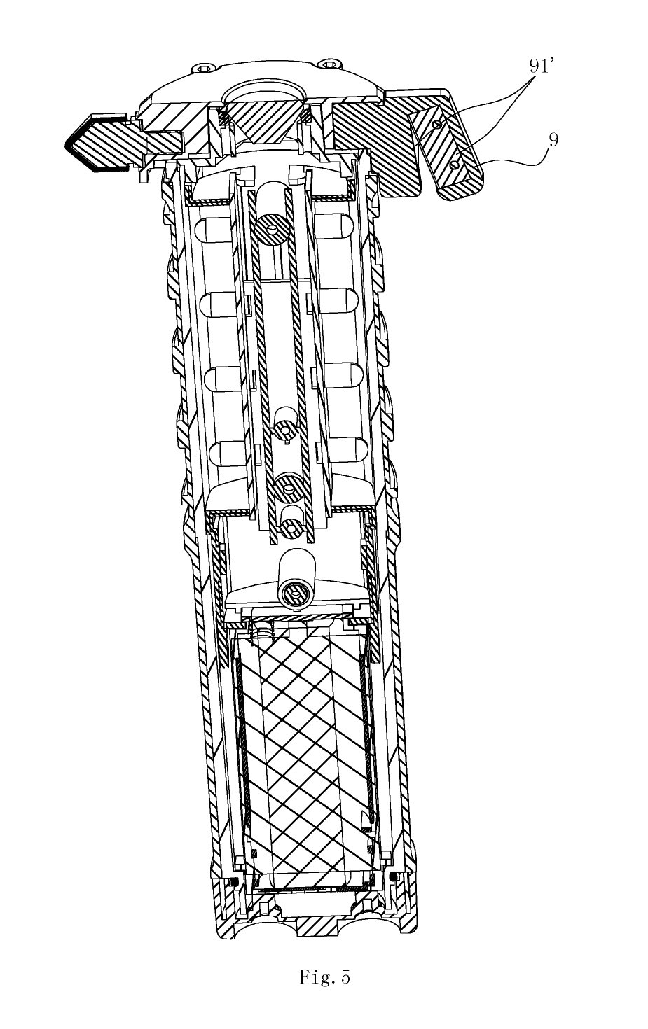

FIG. 4 and FIG. 5 show a second embodiment of the multifunctional flashlight. The difference of the second embodiment comparing the first embodiment is: the seatbelt cutter 9 has two blades 91′ which cross disposed in a scissor. It can increase the cutting efficiency of the seatbelt cutter 9.

1. A multifunctional flashlight comprising:
a housing having a head, a hollow tube, and a rear cover, the hollow tube having an upper portion and a lower portion;
a headlamp disposed inside the head;
two groups of LED, a switch, a control circuit board and a holding frame an emergency hammer attached to the head; and
a seatbelt cutter attached to the head, opposing the emergency hammer;
wherein, the holding frame is disposed inside the upper portion of the hollow tube and close to the head;
two groups of LEDs are distributed along the lengthways of the hollow tube, one group of LEDs on a left side and other group of LEDs on a right side of the holding frame;
the switch is disposed on a front side of the holding frame;
the two groups of LED, the headlamp, the control circuit board and the switch are connected to form a lighting circuit;
the switch is a multi-stage switch enabling the two groups of LED and the headlamp to be switched between a lighting mode and a flicking mode.

2. The multifunctional flashlight of claim 1, wherein the hollow tube further comprises an inner tube and an outer tube, the outer tube having an upper portion and a lower portion;
the inner tube is transparent, and has a through hole for the switch to pass through;
the outer tube has a button corresponding to the switch, and the outer tube has a plurality of holes distributed on the outer tube corresponding to the two groups of LED.

3. The multifunctional flashlight of claim 2, wherein the outer tube is made of elastic TPR soft rubber material and wrapped around the inner tube;
the outer tube has a plurality of annular ribs arranged at intervals in the upper portion of the outer tube, and two up and down adjacent holes separated by one annular rib.

4. The multifunctional flashlight of claim 1, wherein the head is made of aluminum material and shaped in sleeve, the head is attached on a top of the hollow tube by screws;
a supporting frame having an upper portion and a lower portion, for the headlamp to disposed on, is provided inside the head;
the upper portion of the supporting frame is attached to the head, the lower portion of the supporting frame is attached to the hollow tube, the lower portion of the supporting frame is resisted against the top of the holding frame.

5. The multifunctional flashlight of claim 4, wherein a lens coaxial with the headlamp is disposed on a top of the head.

6. The multifunctional flashlight of claim 1, wherein the head has a connecting threaded hole transversely disposed at one side of the head;
the emergency hammer has a cone-tip shape head, and the emergency hammer has a rear with a threaded connecting post for threading into the connecting threaded hole,
the emergency hammer has a guard, disposed at middle of the emergency hammer, for protecting the emergency hammer.

7. The multifunctional flashlight of claim 1, wherein the seatbelt cutter includes a blade rest and a blade disposed on the blade rest; and the head has a mount for receiving the blade rest.

8. The multifunctional flashlight of claim 1, wherein a battery rack is disposed inside the hollow tube;
the holding frame has a plurality of protrusions at the bottom of the holding frame and inserted into the battery rack; and
a spring disposed between the battery rack and the holding frame.

9. The multifunctional flashlight of claim 8, wherein the rear cover is coupled to a bottom of the inner tube, and a rear box is provided inside the rear cover and pressing against the battery rack.
